(19) United States
(12) Patent Application Publication
(10) Pub. No.: US 2023/0094570 A1
(43) Pub. Date: Mar. 30, 2023

(54) Three-Dimensional Shaping Device And Plasticized Material Dispensing Device

(71) Applicant: SEIKO EPSON CORPORATION, Tokyo (JP)

(72) Inventor: Masaaki OGIHARA, Matsumoto (JP)

(21) Appl. No.: 17/954,010

(22) Filed: Sep. 27, 2022

(30) Foreign Application Priority Data
Sep. 28, 2021 (JP) 2021-157662

(51) Int. Cl. B29C 64/393; B33Y 30/00; B33Y 50/02; B28B 1/00; B28B 17/00; B22F 10/85; B22F 12/53; B29C 64/209

(52) U.S. Cl. CPC B29C 64/393; B33Y 30/00; B33Y 50/02; B28B 1/001; B28B 17/0081; B22F 10/85; B22F 12/53; B29C 64/209; B29K 2101/12

(57) ABSTRACT

A three-dimensional shaping device includes: a plasticizing unit; a nozzle configured to dispense a plasticized material from a nozzle opening toward a stage; a dispensing amount adjustment unit configured to communicate with the nozzle opening, be provided in a flow path through which the plasticized material flows, and adjust a dispensing amount of the plasticized material from the nozzle opening by changing an area of an opening formed in the flow path; a pressure adjustment unit configured to adjust pressure of the flow path through a branch flow path coupled to the flow path between the dispensing amount adjustment unit and the nozzle opening; and a control unit configured to control the dispensing amount adjustment unit and the pressure adjustment unit. When the control unit changes the dispensing amount from a first dispensing amount to a second dispensing amount, the control unit controls the dispensing amount adjustment unit to change the area of the opening, and then controls the pressure adjustment unit to adjust the pressure of the flow path. The second dispensing amount is a dispensing amount when the plasticized material is dispensed from the nozzle opening.

The present application is based on, and claims priority from JP Application Serial Number 2021-157662, filed Sep. 28, 2021, the disclosure of which is hereby incorporated by reference herein in its entirety.

### BACKGROUND

### 1. Technical Field

The present disclosure relates to a three-dimensional shaping device and a plasticized material dispensing device.

### 2. Related Art

There is known a three-dimensional shaping device that shapes a three-dimensional shaped object by dispensing and laminating a plasticized material and curing the material.

For example, JP-A-2019-81263 discloses a three-dimensional shaping device including a flow path through which a molten material flows, a nozzle that communicates with the flow path and dispenses the molten material from a dispensing port, and a flow path adjustment mechanism including a butterfly valve provided in the flow path. In JP-A-2019-81263, a flow rate of the molten material flowing through the flow path is adjusted by rotation of the butterfly valve.

However, in the three-dimensional shaping device as described above, it is difficult to accurately change a dispensing amount due to a time lag caused by a flow path length from the butterfly valve to the dispensing port or a pressure fluctuation of the flow path occurring at the time of adjusting the butterfly valve.

### SUMMARY

One aspect of a three-dimensional shaping device according to the present disclosure includes: a plasticizing unit configured to plasticize a material to generate a plasticized material; a nozzle having a nozzle opening and configured to dispense the plasticized material from the nozzle opening toward a stage; a dispensing amount adjustment unit configured to communicate with the nozzle opening, be provided in a flow path through which the plasticized material flows, and adjust a dispensing amount of the plasticized material from the nozzle opening by changing an area of an opening formed in the flow path; a pressure adjustment unit configured to adjust pressure of the flow path through a branch flow path coupled to the flow path between the dispensing amount adjustment unit and the nozzle opening; and a control unit configured to control the dispensing amount adjustment unit and the pressure adjustment unit. When the control unit changes the dispensing amount from a first dispensing amount to a second dispensing amount, the control unit controls the dispensing amount adjustment unit to change the area of the opening, and then controls the pressure adjustment unit to adjust the pressure of the flow path. The second dispensing amount is a dispensing amount when the plasticized material is dispensed from the nozzle opening.

One aspect of a plasticized material dispensing device according to the present disclosure includes: a plasticizing unit configured to plasticize a material to generate a plasticized material; a nozzle having a nozzle opening and configured to dispense the plasticized material from the nozzle opening; a dispensing amount adjustment unit configured to communicate with the nozzle opening, be provided in a flow path through which the plasticized material flows, and adjust a dispensing amount of the plasticized material from the nozzle opening by changing an area of an opening formed in the flow path; a pressure adjustment unit configured to adjust pressure of the flow path through a branch flow path coupled to the flow path between the dispensing amount adjustment unit and the nozzle opening; and a control unit configured to control the dispensing amount adjustment unit and the pressure adjustment unit. When the control unit changes the dispensing amount from a first dispensing amount to a second dispensing amount, the control unit controls the dispensing amount adjustment unit to change the area of the opening, and then controls the pressure adjustment unit to adjust the pressure of the flow path. The second dispensing amount is a dispensing amount when the plasticized material is dispensed from the nozzle opening.

### BRIEF DESCRIPTION OF THE DRAWINGS

FIG. 1 is a cross-sectional view schematically showing a three-dimensional shaping device according to the present embodiment.

FIG. 2 is a perspective view schematically showing a flat screw of the three-dimensional shaping device according to the present embodiment.

FIG. 3 is a plan view schematically showing a barrel of the three-dimensional shaping device according to the present embodiment.

FIG. 4 is a diagram for showing an operation of a dispensing amount adjustment unit of the three-dimensional shaping device according to the present embodiment.

FIG. 5 is a diagram for showing an operation of the dispensing amount adjustment unit of the three-dimensional shaping device according to the present embodiment.

FIG. 6 is a diagram for showing an operation of the dispensing amount adjustment unit of the three-dimensional shaping device according to the present embodiment.

FIG. 7 is a flowchart for showing processing of a control unit of the three-dimensional shaping device according to the present embodiment.

FIG. 8 is a table for showing shaping data of the three-dimensional shaping device according to the present embodiment.

FIG. 9 is a cross-sectional view for showing shaping layer forming processing of the three-dimensional shaping device according to the present embodiment.

FIG. 10 is a flowchart for showing processing of the control unit of the three-dimensional shaping device according to the present embodiment.

### DESCRIPTION OF EXEMPLARY EMBODIMENTS

Hereinafter, a preferred embodiment of the present disclosure will be described in detail with reference to drawings. The embodiment described below does not unduly limit contents of the present disclosure described in the claims. Further, all of configurations to be described below are not necessarily essential elements of the present disclosure.

### 1. Three-Dimensional Shaping Device

### 1.1. Overall Configuration

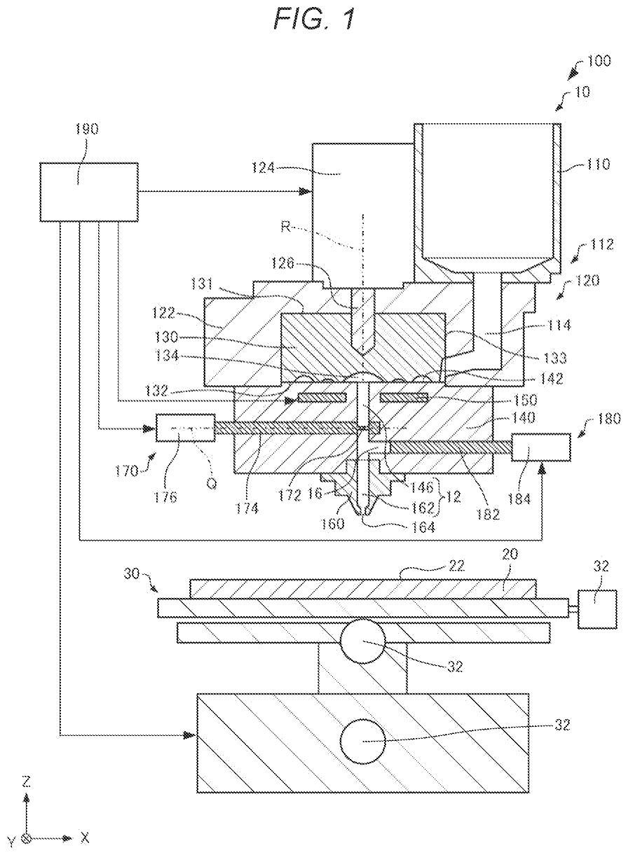

First, a three-dimensional shaping device according to the present embodiment will be described with reference to the drawings. FIG. 1 is a cross-sectional view schematically showing a three-dimensional shaping device 100 according to the present embodiment. FIG. 1 shows an X axis, a Y axis, and a Z axis as three axes orthogonal to one another. An X-axis direction and a Y-axis direction are, for example, horizontal directions. A Z-axis direction is, for example, a vertical direction.

As shown in FIG. 1, the three-dimensional shaping device 100 includes, for example, a shaping unit 10, a stage 20, and a moving mechanism 30.

The three-dimensional shaping device 100 drives the moving mechanism 30 to change a relative position between a nozzle 160 and the stage 20 while dispensing a plasticized material from the nozzle 160 of the shaping unit 10 onto the stage 20. Accordingly, the three-dimensional shaping device 100 shapes a three-dimensional shaped object having a desired shape on the stage 20. A detailed configuration of the shaping unit 10 will be described later.

The stage 20 is moved by the moving mechanism 30.

The plasticized material dispensed from the nozzle 160 is deposited on a deposition surface 22 of the stage 20 to form the three-dimensional shaped object. The plasticized material may be deposited directly on the deposition surface 22 of the stage 20, or may be deposited on the deposition surface 22 via a sample plate provided on the stage 20.

The moving mechanism 30 changes a relative position between the shaping unit 10 and the stage 20. In the illustrated example, the moving mechanism 30 moves the stage 20 with respect to the shaping unit 10. The moving mechanism 30 is implemented by, for example, a three-axis positioner that moves the stage 20 in the X-axis direction, the Y-axis direction, and the Z-axis direction by a driving force of three motors 32. The motors 32 are controlled by a control unit 190.

The moving mechanism 30 may be configured to move the shaping unit 10 without moving the stage 20. Alternatively, the moving mechanism 30 may be configured to move one of the shaping unit 10 and the stage 20 in the X-axis direction and the Y-axis direction and move the other in the Z-axis direction.

### 1.2. Shaping Unit

As shown in FIG. 1, the shaping unit 10 includes, for example, a material supply unit 110 and a plasticized material dispensing device 112.

A pellet-shaped or powder-shaped material is charged into the material supply unit 110. The material supply unit 110 supplies a material serving as a raw material to the plasticized material dispensing device 112. The material supply unit 110 includes, for example, a hopper. The material supply unit 110 and the plasticized material dispensing device 112 are coupled by a supply path 114 provided below the material supply unit 110. The material charged into the material supply unit 110 is supplied to the plasticized material dispensing device 112 through the supply path 114. The type of the material supplied by the material supply unit 110 will be described later.

The plasticized material dispensing device 112 includes a plasticizing unit 120, the nozzle 160, a dispensing amount adjustment mechanism 170, a pressure adjustment unit 180, and the control unit 190.

The plasticizing unit 120 plasticizes the material in a solid state supplied from the material supply unit 110, generates a paste-shaped plasticized material having fluidity, and supplies the plasticized material to the nozzle 160. The plasticizing unit 120 includes, for example, a screw case 122, a drive motor 124, a flat screw 130, a barrel 140, and a heating unit 150.

“Plasticizing” is a concept including melting, and refers to changing from a solid state to a state having fluidity. Specifically, for a material in which glass transition occurs, the “plasticizing” refers to setting a temperature of the material to be equal to or higher than a glass transition point. In a case of a material in which the glass transition does not occur, the “plasticizing” refers to setting the temperature of the material to be equal to or higher than a melting point.

The screw case 122 is a housing that accommodates the flat screw 130. The barrel 140 is provided on a lower surface of the screw case 122. The flat screw 130 is accommodated in a space surrounded by the screw case 122 and the barrel 140.

The drive motor 124 is provided on an upper surface of the screw case 122. The drive motor 124 is, for example, a servomotor. A shaft 126 of the drive motor 124 is coupled to an upper surface 131 of the flat screw 130. The drive motor 124 is controlled by the control unit 190. Although not shown, the shaft 126 of the drive motor 124 and the upper surface 131 of the flat screw 130 may be coupled to each other via a speed reducer.

The flat screw 130 has a substantially cylindrical shape in which a size in a direction of a rotation axis R is smaller than a size in a direction orthogonal to the direction of the rotation axis R. In the illustrated example, the rotation axis R is parallel to the Z axis. The flat screw 130 is rotated about the rotation axis R by a torque generated by the drive motor 124.

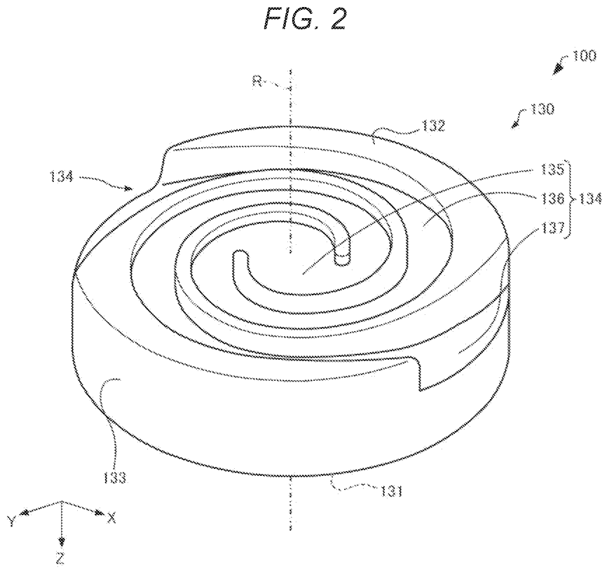

The flat screw 130 has the upper surface 131, a groove forming surface 132 opposite to the upper surface 131, and a side surface 133 coupling the upper surface 131 and the groove forming surface 132. A first groove 134 is formed in the groove forming surface 132. The side surface 133 is, for example, perpendicular to the groove forming surface 132. Here, FIG. 2 is a perspective view schematically showing the flat screw 130. For convenience, FIG. 2 shows a state in which an up-down positional relationship is reversed from a state shown in FIG. 1.

As shown in FIG. 2, the first groove 134 is formed in the groove forming surface 132 of the flat screw 130. The first groove 134 is a helical or swirling groove when viewed from the Z-axis direction. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the illustrated example, the coupling portion 136 is provided in a spiral shape from the central portion 135 toward an outer periphery of the groove forming surface 132. The material introduction portion 137 is formed on the outer periphery of the groove forming surface 132. That is, the material introduction portion 137 is provided on the side surface 133 of the flat screw 130. The material supplied from the material supply unit 110 is introduced from the material introduction portion 137 into the first groove 134, passes through the coupling portion 136 and the central portion 135, and is conveyed to the communication hole 146 formed in the barrel 140.

In the illustrated example, two first grooves 134 are provided. The number of the first grooves 134 is not particularly limited. Although not shown, three or more first grooves 134 may be provided, or only one first groove 134 may be provided. Although not shown, a so-called in-line screw may be provided instead of the flat screw 130.

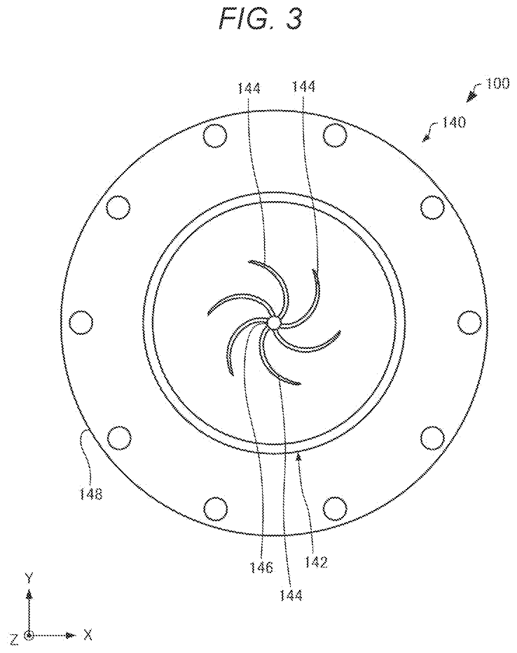

As shown in FIG. 1, the barrel 140 is provided below the flat screw 130. The barrel 140 has a facing surface 142 facing the groove forming surface 132 of the flat screw 130. The barrel 140 has the communication hole 146 communicating with the first groove 134 at the center of the facing surface 142. Here, FIG. 3 is a plan view schematically showing the barrel 140.

As shown in FIG. 3, second grooves 144 and the communication hole 146 are formed in the facing surface 142 of the barrel 140. A plurality of the second grooves 144 are formed. In the illustrated example, six second grooves 144 are formed, but the number of the second grooves 144 is not particularly limited. The plurality of second grooves 144 are formed around the communication hole 146 as viewed in the Z-axis direction. One end of each of the plurality of second grooves 144 is coupled to the communication hole 146, and the second grooves 144 extend spirally from the communication hole 146 toward an outer periphery 148 of the barrel 140. The second grooves 144 have a function of guiding the plasticized material to the communication hole 146.

A shape of the second groove 144 is not particularly limited, and may be, for example, a linear shape. In addition, one end of the second groove 144 may not be coupled to the communication hole 146. Further, the second groove 144 may not be formed in the facing surface 142. However, in consideration of efficiently guiding the plasticized material to the communication hole 146, the second groove 144 is preferably formed in the facing surface 142.

As shown in FIG. 1, the heating unit 150 is provided in the barrel 140. The heating unit 150 is, for example, a bar heater. The heating unit 150 heats the material supplied between the flat screw 130 and the barrel 140. The heating unit 150 is controlled by the control unit 190. The plasticizing unit 120 generates the plasticized material by heating the material while conveying the material toward the communication hole 146 by using the flat screw 130, the barrel 140, and the heating unit 150. The generated plasticized material flows out through the communication hole 146.

The nozzle 160 is provided below the barrel 140. The nozzle 160 and the stage 20 are moved relative to each other. The nozzle 160 is provided with a nozzle flow path 162. The nozzle flow path 162 communicates with the communication hole 146. The nozzle flow path 162 and the communication hole 146 constitute a flow path 12 through which the plasticized material passes. In the illustrated example, the flow path 12 is formed along the Z axis. The nozzle flow path 162 has a nozzle opening 164. The nozzle opening 164 is formed at a front end of the nozzle 160. The plasticized material supplied from the communication hole 146 passes through the nozzle flow path 162 and reaches the nozzle opening 164. The nozzle 160 dispenses the plasticized material supplied from the nozzle opening 164 toward the stage 20.

The dispensing amount adjustment mechanism 170 adjusts an amount of the plasticized material dispensed from the nozzle 160. The dispensing amount adjustment mechanism 170 includes, for example, a dispensing amount adjustment unit 172, a drive shaft member 174, and a valve drive unit 176.

The dispensing amount adjustment unit 172 is provided in the flow path 12. In the illustrated example, the dispensing amount adjustment unit 172 is provided in the communication hole 146, and may be provided in the nozzle flow path 162. The dispensing amount adjustment unit 172 may be provided in an intermediate flow path between the communication hole 146 and the nozzle flow path 162. The dispensing amount adjustment unit 172 adjusts the amount of the plasticized material passing through the flow path 12. Accordingly, the dispensing amount adjustment unit 172 adjusts the dispensing amount of the plasticized material from the nozzle opening 164.

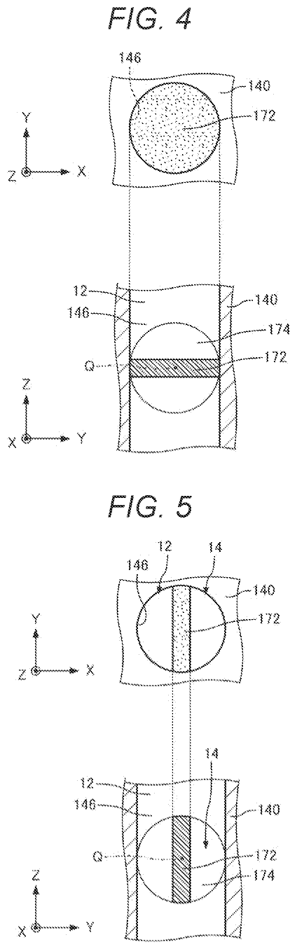

The dispensing amount adjustment unit 172 is a butterfly valve. The dispensing amount adjustment unit 172 is rotatable about a rotation axis Q. In the illustrated example, the rotation axis Q is parallel to the X axis. Here, FIGS. 4 to 6 are diagrams for illustrating an operation of the dispensing amount adjustment unit 172. In FIGS. 4 to 6, a plan view seen from the Z-axis direction is shown on an upper side, and a cross-sectional view parallel to a YZ plane is shown on a lower side.

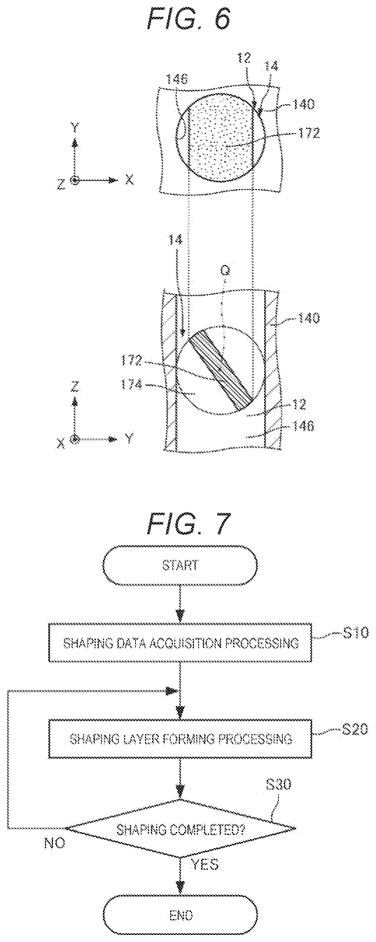

As shown in FIGS. 4 to 6, the dispensing amount adjustment unit 172 changes an area of an opening 14 formed in the flow path 12 by rotating. Accordingly, the dispensing amount adjustment unit 172 adjusts the dispensing amount of the plasticized material from the nozzle opening 164. In the example shown in FIG. 4, the dispensing amount adjustment unit 172 is in a closed state, and the opening is not formed in the flow path 12 by the dispensing amount adjustment unit 172. In this case, the dispensing amount of the plasticized material from the nozzle opening 164 is zero. In the example shown in FIG. 5, the dispensing amount adjustment unit 172 is in a fully open state, and the area of the opening 14 formed in the flow path 12 is maximized. In the example shown in FIG. 6, the dispensing amount adjustment unit 172 is in an intermediate state between the closed state and the fully open state, and the area of the opening 14 is smaller than that in the fully open state.

The “opening 14 formed in the flow path 12” refers to a region of the flow path 12 that does not overlap the dispensing amount adjustment unit 172 when viewed from the Z-axis direction. The “area of the opening 14” refers to a size of the region.

As shown in FIG. 1, the drive shaft member 174 is coupled to the dispensing amount adjustment unit 172. The drive shaft member 174 is provided on the barrel 140. The drive shaft member 174 may be provided integrally with the dispensing amount adjustment unit 172. In the illustrated example, the drive shaft member 174 is a rod-shaped member extending in the X-axis direction.

The valve drive unit 176 is coupled to the drive shaft member 174. The valve drive unit 176 includes, for example, a motor. A driving force generated by the valve drive unit 176 causes the drive shaft member 174 to rotate about the rotation axis Q. With the rotation of the drive shaft member 174, the dispensing amount adjustment unit 172 rotates. The valve drive unit 176 is controlled by the control unit 190.

Although an example in which the dispensing amount adjustment unit 172 is a butterfly valve is described above, the dispensing amount adjustment unit 172 is not limited to the butterfly valve as long as the area of the opening 14 formed in the flow path 12 can be adjusted. For example, the dispensing amount adjustment unit 172 may be a plate-shaped member in which a through hole penetrating in the Z-axis direction is formed, and the area of the opening 14 may be adjusted by moving the plate-shaped member in the X-axis direction. In this case, the opening 14 is a region where the through hole formed in the plate-shaped member and the flow path 12 overlap each other when viewed from the Z-axis direction.

The pressure adjustment unit 180 adjusts pressure of the flow path 12. The pressure adjustment unit 180 may decrease or increase the pressure of the flow path 12. The pressure adjustment unit 180 includes, for example, a plunger 182 and a plunger drive unit 184.

The plunger 182 is provided in a branch flow path 16. The branch flow path 16 is coupled to the flow path 12 between the dispensing amount adjustment unit 172 and the nozzle opening 164. That is, the branch flow path 16 is coupled downstream in the path of the plasticized material with respect to a portion of the flow path 12 where the dispensing amount adjustment unit 172 is provided. In the illustrated example, the branch flow path 16 is coupled to the communication hole 146, and may be coupled to the nozzle flow path 162. The branch flow path 16 extends, for example, from the flow path 12 in a +X-axis direction.

The plunger 182 is, for example, a rod-shaped member extending in the X-axis direction. The plunger 182 is in sliding contact with an inner surface of the branch flow path 16. In the illustrated example, the inner surface of the branch flow path 16 is defined by the barrel 140. The barrel 140 that defines the inner surface of the branch flow path 16 functions as a cylinder that comes into contact with the plunger 182.

The plunger 182 moves in the branch flow path 16 in the X-axis direction. When the plunger 182 moves in the +X-axis direction, the plasticized material passing through the flow path 12 is aspirated into the branch flow path 16, and the pressure in the flow path 12 decreases. In this case, the dispensing amount of the plasticized material from the nozzle opening 164 is reduced. When the plunger 182 moves in a −X-axis direction, the plasticized material in the branch flow path 16 is press-fitted into the flow path 12, and the pressure of the flow path 12 increases. In this case, the dispensing amount of the plasticized material from the nozzle opening 164 is increased. The pressure adjustment unit 180 adjusts the pressure of the flow path 12 through the branch flow path 16.

The plunger drive unit 184 is coupled to the plunger 182. The plunger drive unit 184 includes, for example, a motor. The plunger 182 is moved in the X-axis direction by a driving force generated by the plunger drive unit 184. The plunger drive unit 184 is controlled by the control unit 190.

Although an example in which the pressure adjustment unit 180 includes the plunger 182 is described above, the configuration of the pressure adjustment unit 180 is not particularly limited as long as the pressure of the flow path 12 can be adjusted. The pressure adjustment unit 180 may be, for example, a piston pump or the like that performs aspiration or the like by moving a piston.

The control unit 190 is implemented by, for example, a computer including a processor, a main storage device, and an input and output interface that inputs and outputs a signal to and from the outside. The control unit 190 exerts various functions, for example, by the processor executing a program read into the main storage device. The control unit 190 controls, for example, the motor 32 of the moving mechanism 30, the drive motor 124, the heating unit 150, the dispensing amount adjustment mechanism 170, and the pressure adjustment unit 180. The control unit 190 may be implemented by a combination of a plurality of circuits instead of a computer. Hereinafter, processing of the control unit 190 will be described.

### 1.3. Processing of Control Unit

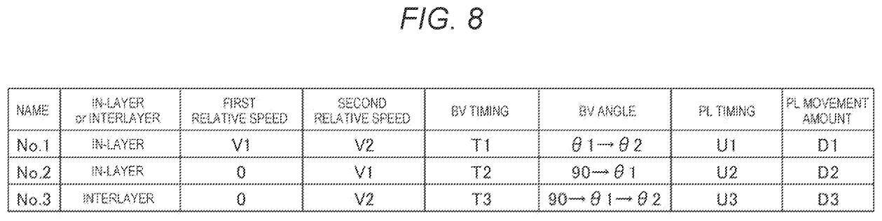

FIG. 7 is a flowchart for illustrating the processing of the control unit 190. For example, the user operates an operation unit, which is not shown, to output a processing start signal for starting processing to the control unit 190. The operation unit includes, for example, a mouse, a keyboard, and a touch panel. Upon receiving the processing start signal, the control unit 190 starts the processing. Hereinafter, each processing will be described.

### 1.3.1. Shaping Data Acquisition Processing

First, as shown in FIG. 7, as step S10, the control unit 190 performs shaping data acquisition processing of acquiring shaping data for shaping a three-dimensional shaped object.

The shaping data is created by, for example, causing a slicer software, which is installed in a computer coupled to the three-dimensional shaping device 100, to read shape data. The shape data is data representing a target shape of the three-dimensional shaped object created using three-dimensional computer aided design (CAD) software, three-dimensional computer graphics (CG) software, and the like. As the shape data, for example, data in a standard triangulated language (STL) format, or an additive manufacturing file format (AMF) is used. The slicer software divides the target shape of the three-dimensional shaped object into layers having a predetermined thickness, and creates shaping data for each layer. The shaping data is represented by a G code or the like.

The shaping data includes information on a type of the material supplied from the material supply unit 110, a heating temperature of the material, a movement path of the nozzle 160 with respect to the stage 20, a relative speed between the stage 20 and the nozzle 160, and the like. FIG. 8 is a table for illustrating information included in the shaping data. In the following description, the dispensing amount adjustment unit 172 is described as a butterfly valve. The “relative speed between the stage 20 and the nozzle 160” is also simply referred to as a “relative speed”. The “dispensing amount of the plasticized material from the nozzle openings 164” is also simply referred to as a “dispensing amount”.

As shown in FIG. 8, the shaping data includes conditions of the dispensing amount adjustment mechanism 170 and the pressure adjustment unit 180 when the relative speed is changed from a first relative speed to a second relative speed. In the illustrated example, three types of patterns “No. 1” to “No. 3” are shown, and the number of patterns is not particularly limited. For example, the number of patterns is the same as the number of variations of the change in the relative speed.

In FIG. 8, “No. 1” and “No. 2” which are “in-layer” are information in any layer when the three-dimensional shaped object is divided into a plurality of layers. “No. 3”, which is “interlayer”, is information in an interlayer from any layer to a next layer when formation of any layer is completed and formation of the next layer is started.

“No. 1” is information when a state of a first relative speed V1 is changed to a state of a second relative speed V2 in the “in-layer”. V2 is a value larger than V1. “No. 2” is a case where the state of the first relative speed being zero, that is, the state in which the nozzle 160 is stopped with respect to the stage 20 is changed to the state of the second relative speed V2 in the “in-layer”. “No. 3” is a case where the state of the first relative speed being zero is changed to the state of the second relative speed V2 in the “interlayer”.

In FIG. 8, the “in-layer” indicates a change in the relative speed in any layer when the three-dimensional shaped object is divided into a plurality of layers. The “interlayer” indicates a change in the relative speed in an interlayer from any layer to the next layer when the formation of any layer is completed and the formation of the next layer is started.

In FIG. 8, a “BV timing” indicates a timing at which an angle of the dispensing amount adjustment unit 172 is changed. For example, when the BV timing is T1 seconds, the angle of the dispensing amount adjustment unit 172 is changed T1 seconds before the relative speed is changed. More specifically, a change in the angle of the dispensing amount adjustment unit 172 is instructed at the timing T1 seconds before the change in the relative speed is instructed. A “BV angle” indicates a rotation angle of the dispensing amount adjustment unit 172 when the dispensing amount adjustment unit 172 sets the fully open state to 0° as shown in FIG. 5. As shown in FIG. 4, in a state where the dispensing amount adjustment unit 172 is closed, the BV angle is 90°.

As shown in FIG. 8, in “No. 1”, the BV angle is changed from θ1 to θ2 at the BV timing T1. θ1 is an angle larger than 0° and smaller than 90°. θ2 is an angle larger than 0° and smaller than θ1. In “No. 2”, the BV angle is changed from 90° to θ1 at a BV timing T2. T2 is a time longer than T1. In “No. 3”, the BV angle is changed from 90° to θ1 and further changed from θ1 to θ2 at a BV timing T3. T3 is a time longer than T2.

Here, in a state where the BV angle is 90° and the dispensing amount is zero, since the dispensing amount adjustment unit 172 is closed, the pressure at a portion of the flow path 12 upstream of the dispensing amount adjustment unit 172 increases as time elapses. Therefore, when a predetermined time elapses in the state where the dispensing amount is zero, when the BV angle is set to θ2 at once, the plasticized material may flow out downstream of the dispensing amount adjustment unit at once, and the pressure in the flow path may not be adjusted by the pressure adjustment unit, resulting in an unexpected dispensing amount. In particular, in the case of “interlayer”, the state in which the dispensing amount is zero continues for a long time, so that such a problem is likely to occur.

Therefore, as shown in FIG. 8, in “No. 3” which is the “interlayer”, the BV angle is decreased in a stepwise manner, and the dispensing amount is increased in a stepwise manner.

In FIG. 8, a “PL timing” indicates a timing at which the plunger 182 is moved. For example, when the PL timing is U1 seconds, the plunger 182 is moved U1 seconds before the relative speed is changed. More specifically, the movement of the plunger 182 is instructed at the timing U1 seconds before the change of the relative speed is instructed. A “PL movement amount” indicates a movement amount of the plunger 182. In the “PL movement amount”, a case where the plunger 182 is moved in a direction approaching the flow path 12 may be indicated by a positive value, and a case where the plunger 182 is moved in a direction away from the flow path 12 may be indicated by a negative value.

In “No. 1”, the PL movement amount is D1 at the PL timing U1. U1 is a time shorter than T1. In “No. 2”, the PL movement amount is D2 at a PL timing U2. U2 is a time longer than U1 and shorter than T2. D2 is smaller than D1. In “No. 3”, the PL movement amount is D3 at a PL timing U3. U3 is a time longer than U2 and shorter than T3. D3 is larger than D1.

When the dispensing amount is changed from the first dispensing amount to the second dispensing amount, the pressure adjustment unit 180 may be controlled in a stepwise manner to adjust the pressure in the flow path 12 in a stepwise manner. By controlling the pressure adjustment unit 180 in the stepwise manner, it is possible to prevent the unexpected dispensing amount.

The BV timing and the PL timing may be determined according to the type of the plasticized material. For example, when viscoelasticity of the plasticized material is high, a movement time of the plasticized material from the dispensing amount adjustment unit 172 to the nozzle opening 164 is longer than when the viscoelasticity of the plasticized material is low, and thus the BV timing and the PL timing may be lengthened.

The BV timing and the PL timing may be determined according to the temperature of the plasticized material. The “temperature of the plasticized material” is a temperature when the plasticized material is heated by the heating unit 150. For example, when the temperature of the plasticized material is low, the viscoelasticity is higher than when the temperature of the plasticized material is high, and thus the BV timing and the PL timing may be lengthened.

The BV timing and the PL timing may be determined according to a degree of change in the relative speed. For example, when the degree of change in the relative speed is large, the BV timing and the PL timing may be lengthened than when the degree of change in the relative speed is small.

In this way, a timing of changing an area of the opening 14 by the dispensing amount adjustment unit 172 and a timing of adjusting the pressure of the flow path 12 by the pressure adjustment unit 180 may be determined according to at least one of the type of the plasticized material, the temperature of the plasticized material, and the degree of change in the relative speed.

The PL movement amount may be determined according to the degree of change in the BV angle. For example, when the degree of change in the BV angle is large, the PL movement amount may be made larger than when the degree of change in the BV angle is small. In this way, the pressure of the flow path 12 adjusted by the pressure adjustment unit 180 may be determined according to the degree of change in the area of the opening 14 by the dispensing amount adjustment unit 172. The PL movement amount may be determined by a pressure difference in the flow path 12 before and after the change in the relative speed.

For example, the control unit 190 acquires shaping data including the information described above from a computer coupled to the three-dimensional shaping device 100 or a recording medium such as a universal serial bus (USB) memory.

### 1.3.2. Shaping Layer Forming Processing

Next, as shown in FIG. 7, as step S20, the control unit 190 performs shaping layer forming processing of forming a shaping layer on the stage 20.

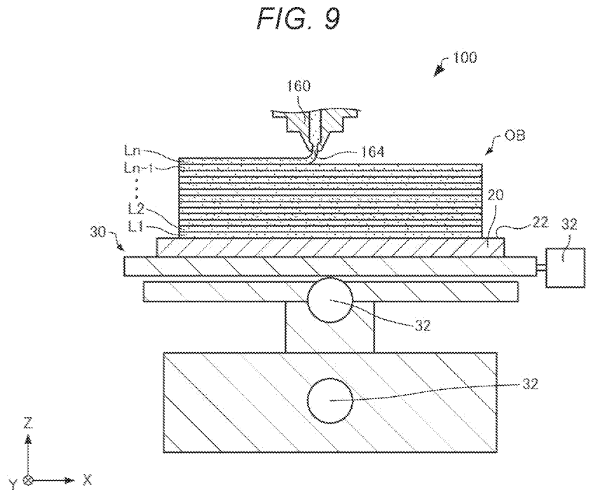

Specifically, the control unit 190 plasticizes the material supplied between the flat screw 130 and the barrel 140 to generate a plasticized material, and causes the nozzle 160 to dispense the plasticized material. The control unit 190 continues to generate the plasticized material until the shaping layer forming processing is completed. Here, FIG. 9 is a cross-sectional view for illustrating the shaping layer forming processing.

As shown in FIG. 9, the control unit 190 controls the moving mechanism 30 based on the acquired shaping data to change a relative position between the nozzle 160 and the deposition surface 22 of the stage 20, and causes the nozzle 160 to dispense the plasticized material toward the deposition surface 22.

Specifically, before the shaping layer forming processing is started, that is, before formation of a first layer L1, which is a first layer of the shaping layer, is started, the nozzle 160 is disposed at an initial position in the −X-axis direction with respect to an end portion of the stage 20 in the −X-axis direction. When the shaping layer forming processing is started, as shown in FIG. 9, the control unit 190 controls the moving mechanism 30 to move the nozzle 160 relative to the stage 20 in the +X-axis direction. When the nozzle 160 passes over the stage 20, the plasticized material is dispensed from the nozzle 160. Accordingly, the first layer L1 is formed. In FIG. 9, n is any natural number, and layers up to an n-th layer Ln, which is the n-th layer, are illustrated.

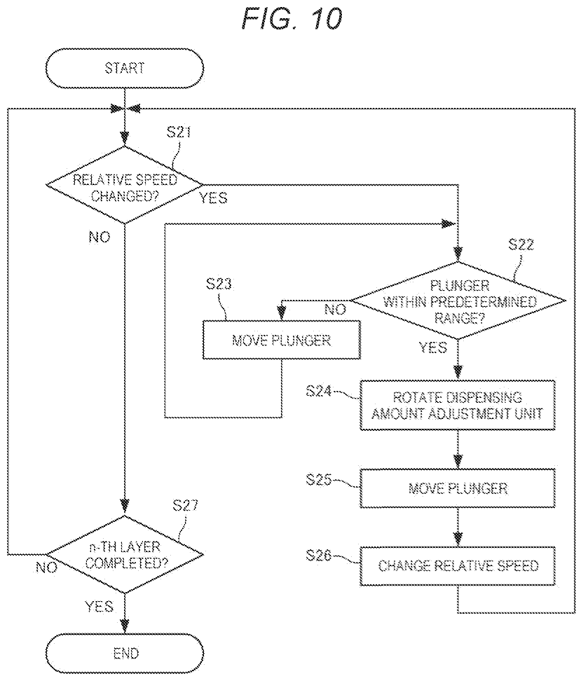

FIG. 10 is a flowchart for illustrating the shaping layer forming processing in more detail.

In the shaping layer forming processing, as shown in FIG. 10, as step S21, the control unit 190 performs processing of determining whether to change a relative speed. Specifically, the control unit 190 performs processing of determining whether to change the relative speed based on the acquired shaping data. For example, when the nozzle 160 linearly moving with respect to the stage 20 bends, it is necessary to change the relative speed.

When it is determined to change the relative speed (“YES” in step S21), as step S22, the control unit 190 performs processing of determining whether a position of the plunger 182 is within a predetermined range. For example, every time the plunger 182 is moved in steps S23 and S25, the control unit 190 stores the position of the plunger 182 in a storage unit, which is not shown, and determines whether the position of the plunger 182 read from the storage unit is within the predetermined range. Alternatively, the three-dimensional shaping device 100 may include a sensor, which is not shown, that detects the position of the plunger 182. The control unit 190 may determine whether the position of the plunger 182 detected by the sensor is within the predetermined range. The “predetermined range” in step S22 is information included in the shaping data.

When it is determined that the position of the plunger 182 is out of the predetermined range (“NO” in step S22), as step S23, the control unit 190 controls the pressure adjustment unit 180 to move the plunger 182 by a predetermined amount in a direction approaching the predetermined range. Specifically, the control unit 190 drives the plunger drive unit 184 to move the plunger 182 by the predetermined amount in the direction approaching the predetermined range. For example, when the position of the plunger 182 is shifted in the +X-axis direction from the predetermined range, the control unit 190 moves the plunger 182 in the −X-axis direction by the predetermined amount.

The “predetermined amount” is an amount by which an amount of change in a line width due to the movement of the plunger 182 in step S23 can be kept within 5%. The “line width” is a size in a second direction orthogonal to a first direction of the plasticized material dispensed onto the stage 20 in a plan view when the nozzle 160 moves in the first direction with respect to the stage 20 to dispense the plasticized material.

The “predetermined range” and the “predetermined amount” in step S23 are information included in the shaping data. The control unit 190 repeats step S22 and step S23 until it is determined in step S22 that the position of the plunger 182 is within the predetermined range.

When it is determined that the position of the plunger 182 is within the predetermined range (“YES” in step S22), as step S24, the control unit 190 controls the dispensing amount adjustment unit 172 to rotate the dispensing amount adjustment unit 172, and performs processing of changing the area of the opening 14. Specifically, the control unit 190 rotates the dispensing amount adjustment unit 172 by driving the valve drive unit 176 to rotate the drive shaft member 174 based on the shaping data.

For example, as in “No. 1” shown in FIG. 8, when the relative speed is changed from the first relative speed V1 to the second relative speed V2, the control unit 190 changes the BV angle of the dispensing amount adjustment unit 172 from θ1 to θ2 based on the shaping data, and changes the area of the opening 14. For example, as in “No. 3”, when the control unit 190 changes the dispensing amount from the first dispensing amount, which is zero, to the second dispensing amount, the control unit 190 controls the dispensing amount adjustment unit 172 to increase the area of the opening 14 in a stepwise manner.

Next, as shown in FIG. 10, as step S25, the control unit 190 performs processing of controlling the pressure adjustment unit 180 to move the plunger 182 and adjust the pressure of the flow path 12. Specifically, the control unit 190 moves, based on the shaping data, the plunger 182 by driving the plunger drive unit 184. For example, as in “No. 1” shown in FIG. 8, when the relative speed is changed from the first relative speed V1 to the second relative speed V2, the control unit 190 moves the plunger 182 by D1 based on the shaping data. In this way, when changing the dispensing amount from the first dispensing amount to the second dispensing amount, the control unit 190 controls the dispensing amount adjustment unit 172 to change the area of the opening 14, and then controls the pressure adjustment unit 180 to adjust the pressure of the flow path 12. The control unit 190 may control the dispensing amount adjustment unit 172 to change the area of the opening 14, and then control the pressure adjustment unit 180 in a stepwise manner to adjust the pressure of the flow path 12 in a stepwise manner.

The control unit 190 can change the dispensing amount of the plasticized material from the nozzle 160 from the first dispensing amount to the second dispensing amount by step S25 and step S26. The second dispensing amount is a dispensing amount when the plasticized material is dispensed from the nozzle opening 164, and is not zero. The first dispensing amount may be zero or may be larger than zero. The first dispensing amount may be larger or smaller than the second dispensing amount.

Next, as shown in FIG. 10, as step S26, the control unit 190 performs processing of changing the relative speed. Specifically, the control unit 190 drives the motor 32 of the moving mechanism 30 based on the shaping data. Thereafter, the control unit 190 returns the processing to step S21.

When it is determined that the relative speed is not to be changed (“NO” in step S21), as step S27, the control unit 190 performs processing of determining whether the formation of the n-th layer is completed based on the shaping data. When it is determined that the formation of the n-th layer is not completed (“NO” in step S27), the control unit 190 returns the processing to step S21. When it is determined that the formation of the n-th layer is completed (“YES” in step S27), the control unit 190 ends the shaping layer forming processing.

In the above description, an example in which the processing of determining whether the position of the plunger 182 is out of the predetermined range and the processing of moving the plunger 182 according to a result of the determination are performed before step S24 is disclosed. However, these processing may be performed after step S24 and before step S25, may be performed after step S25 and before step S26, or may be performed after step S26. Alternatively, these processing may be repeatedly performed at a predetermined timing while the shaping layer forming processing is performed. However, in order to prevent the processing in the control unit 190 from becoming complicated, it is preferable that these processing are not performed simultaneously with steps S24, S25, and S26.

### 1.3.3. Determination Processing of Whether Formation of All Shaping Layers is Completed

Next, as shown in FIG. 7, as step S30, the control unit 190 performs determination processing of determining whether the formation of all the shaping layers is completed based on the shaping data. When it is determined that the formation of all the shaping layers is not completed (“NO” in step S30), the control unit 190 returns the processing to step S20. The control unit 190 repeats step S20 and step S30 until it is determined that the formation of all the shaping layers is completed. When it is determined that the formation of all the shaping layers is completed (“YES” in step S30), the control unit 190 ends the processing.

### 1.4. Function and Effect

The three-dimensional shaping device 100 includes the dispensing amount adjustment unit 172 that communicates with the nozzle opening 164, is provided in the flow path 12 through which the plasticized material flows, and adjusts the dispensing amount of the plasticized material from the nozzle opening 164 by changing the area of the opening 14 formed in the flow path 12. The three-dimensional shaping device 100 further includes the pressure adjustment unit 180 that adjusts the pressure of the flow path 12 through the branch flow path 16 coupled to the flow path 12 between the dispensing amount adjustment unit 172 and the nozzle opening 164. When changing the dispensing amount from the first dispensing amount to the second dispensing amount, the control unit 190 of the three-dimensional shaping device 100 controls the dispensing amount adjustment unit 172 to change the area of the opening 14, and then controls the pressure adjustment unit 180 to adjust the pressure of the flow path 12.

As described above, in the three-dimensional shaping device 100, when the dispensing amount is changed, by controlling the pressure adjustment unit 180 after controlling the dispensing amount adjustment unit 172, it is possible to reduce a time lag caused by a length of the flow path 12 from the dispensing amount adjustment unit 172 to the nozzle opening 164, and to correct the pressure fluctuation of the flow path 12 occurring at the time of adjustment of the dispensing amount adjustment unit 172. Accordingly, the dispensing amount can be accurately changed.

In the three-dimensional shaping device 100, the nozzle 160 and the stage 20 are relatively moved. When the relative speed between the nozzle 160 and the stage 20 is changed, the control unit 190 changes the dispensing amount. For example, when the relative speed increases, the control unit 190 increases the dispensing amount. When the relative speed decreases, the control unit 190 decreases the dispensing amount. Therefore, in the three-dimensional shaping device 100, it is possible to reduce fluctuation in the line width due to the change in the relative speed.

In the three-dimensional shaping device 100, the control unit 190 controls the dispensing amount adjustment unit 172 to change the area of the opening 14 before the relative speed is changed, and controls the pressure adjustment unit 180 to adjust the pressure of the flow path 12 after the area of the opening 14 is changed and before the relative speed is changed. Therefore, in the three-dimensional shaping device 100, even if the time lag occurs in the control of the dispensing amount adjustment unit 172 and the fluctuation in the dispensing amount, the time lag can be reduced.

The control unit 190 may control the dispensing amount adjustment unit 172 to change the area of the opening 14 after the relative speed is changed, or may control the pressure adjustment unit 180 to adjust the pressure of the flow path 12 after the relative speed is changed.

In the three-dimensional shaping device 100, a timing of changing the area of the opening 14 by the dispensing amount adjustment unit 172 and a timing of adjusting the pressure of the flow path 12 by the pressure adjustment unit 180 may be determined according to at least one of the type of the plasticized material, the temperature of the plasticized material, and the degree of change in the relative speed. Therefore, in the three-dimensional shaping device 100, it is possible to change the area of the opening 14 and adjust the pressure of the flow path 12, for example, at a timing suitable for the type of the plasticized material. Further, it is possible to change the area of the opening 14 and adjust the pressure of the flow path 12, for example, at a timing suitable for the temperature of the plasticized material. Furthermore, it is possible to change the area of the opening 14 and adjust the pressure of the flow path 12, for example, at a timing suitable for the degree of change in the relative speed.

In the three-dimensional shaping device 100, the pressure of the flow path 12 adjusted by the pressure adjustment unit is determined according to the degree of change in the area of the opening 14. Therefore, in the three-dimensional shaping device 100, the pressure of the flow path 12 can be set to a magnitude suitable for the degree of change in the area of the opening 14.

In the three-dimensional shaping device 100, the pressure adjustment unit 180 includes the plunger 182 that moves in the branch flow path 16. When the position of the plunger 182 is out of a predetermined range, the control unit 190 controls the pressure adjustment unit 180 to move the plunger 182 by a predetermined amount in a direction approaching the predetermined range during shaping. Therefore, in the three-dimensional shaping device 100, it is possible to prevent the plunger 182 from moving to a limit, for example, in the +X-axis direction and to prevent the pressure of the flow path 12 from being unadjustable to decrease. The term “during shaping” means that the shaping layer forming processing is being performed.

In the three-dimensional shaping device 100, when the control unit 190 changes the dispensing amount from the first dispensing amount, which is zero, to the second dispensing amount, the control unit 190 controls the dispensing amount adjustment unit 172 to increase the area of the opening 14 in a stepwise manner. Therefore, in the three-dimensional shaping device 100, it is possible to reduce the pressure in the portion of the flow path 12 upstream of the dispensing amount adjustment unit 172 in a stepwise manner. Accordingly, it is possible to reduce the possibility that the plasticized material flows out at once downstream of the dispensing amount adjustment unit 172.

In the three-dimensional shaping device 100, when changing the dispensing amount from the first dispensing amount to the second dispensing amount, the control unit 190 may control the dispensing amount adjustment unit 172 to change the area of the opening 14 and then control the pressure adjustment unit 180 in a stepwise manner to adjust the pressure in the flow path 12 in a stepwise manner. Therefore, in the three-dimensional shaping device 100, it is possible to prevent an unexpected dispensing amount.

### 1.5. Material

Examples of the material supplied from the material supply unit 110 include materials having various materials such as a thermoplastic material, a metal material, and a ceramic material as main materials. Here, the “main material” means a material serving as a center forming the shape of the shaped object, and means a material having a content of 50 mass % or more in the shaped object. The materials described above include those acquired by melting these main materials alone, and those acquired by melting a part of components contained together with the main materials into a paste form.

As the thermoplastic material, for example, a thermoplastic resin can be used. Examples of the thermoplastic resin include: general-purpose engineering plastics such as acrylonitrile butadiene styrene (ABS) resin, polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate; and engineering plastics such as polysulfone, polyether sulfone, polyphenylene sulfide, polyarylate, polyimide, polyamideimide, polyetherimide, and PEEK.

Additives such as a wax, a flame retardant, an antioxidant, and a heat stabilizer may be mixed into the thermoplastic material in addition to a pigment, a metal, a ceramic. In the plasticizing unit 120, the thermoplastic material is plasticized and converted into a molten state by rotation of the flat screw 130 and heating of the heating unit 150. The plasticized material generated in this manner is injected from the nozzle 160 and then cured by a decrease in temperature. It is desirable that the thermoplastic material is heated to a temperature equal to or higher than the glass transition point thereof and injected from the nozzle 160 in a state of being completely melted.

In the plasticizing unit 120, for example, a metal material may be used as the main material instead of the thermoplastic material described above. In this case, it is desirable that a powder material acquired by powdering the metal material is mixed with a component that melts when the plasticized material is generated, and the mixture is charged into the plasticizing unit 120.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material described above. Examples of the ceramic material include an oxide ceramic such as silicon dioxide, titanium dioxide, aluminum oxide, and zirconium oxide, and a non-oxide ceramic such as aluminum nitride.

A powder material of the metal material or the ceramic material supplied from the material supply unit 110 may be a mixed material in which a plurality of types of powder of a single metal or powder of an alloy and powder of a ceramic material are mixed. In addition, the powder material of the metal material or the ceramic material may be coated with, for example, the above-described thermoplastic resin or another thermoplastic resin. In this case, in the plasticizing unit 120, the thermoplastic resin may be melted to exhibit fluidity.

For example, a solvent can be added to the powder material of the metal material or the ceramic material supplied from the material supply unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material of the metal material or the ceramic material supplied from the material supply unit 110. Examples of the binder include acrylic resins, epoxy resins, silicone resins, cellulose-based resins, other synthetic resins, polylactic acid (PLA), polyamide (PA), polyphenylene sulfide (PPS), PEEK, and other thermoplastic resins.

The embodiment and modification described above are merely examples, and the present disclosure is not limited thereto. For example, each embodiment and each modification can be combined as appropriate.

The present disclosure includes a configuration substantially the same as the configurations described in the embodiment, for example, a configuration having the same functions, methods, and results, or a configuration having the same objects and effects. In addition, the present disclosure includes a configuration in which an inessential portion of the configurations described in the embodiment is replaced. The present disclosure includes a configuration having the same action and effect as the configuration described in the embodiment, or a configuration capable of achieving the same object. The present disclosure includes a configuration in which a known technique is added to the configuration described in the embodiment.

The following contents are derived from the above embodiment and modification.

One aspect of a three-dimensional shaping device includes: a plasticizing unit configured to plasticize a material to generate a plasticized material; a nozzle having a nozzle opening and configured to dispense the plasticized material from the nozzle opening toward a stage; a dispensing amount adjustment unit configured to communicate with the nozzle opening, be provided in a flow path through which the plasticized material flows, and adjust a dispensing amount of the plasticized material from the nozzle opening by changing an area of an opening formed in the flow path; a pressure adjustment unit configured to adjust pressure of the flow path through a branch flow path coupled to the flow path between the dispensing amount adjustment unit and the nozzle opening; and a control unit configured to control the dispensing amount adjustment unit and the pressure adjustment unit. When the control unit changes the dispensing amount from a first dispensing amount to a second dispensing amount, the control unit controls the dispensing amount adjustment unit to change the area of the opening, and then controls the pressure adjustment unit to adjust the pressure of the flow path. The second dispensing amount is a dispensing amount when the plasticized material is dispensed from the nozzle opening.

According to the three-dimensional shaping device, it is possible to accurately change the dispensing amount.

In one aspect of the three-dimensional shaping device, the nozzle and the stage may be moved relative to each other, and when a relative speed between the nozzle and the stage is changed, the control unit may change the dispensing amount.

According to the three-dimensional shaping device, it is possible to reduce fluctuation in a line width due to the change in the relative speed.

In one aspect of the three-dimensional shaping device, the control unit may be configured to control the dispensing amount adjustment unit to change the area of the opening before the relative speed is changed, and control the pressure adjustment unit to adjust the pressure of the flow path after the area of the opening is changed and before the relative speed is changed.

According to the three-dimensional shaping device, even if a time lag occurs in the control of the dispensing amount adjustment unit and the fluctuation of the dispensing amount, the time lag can be reduced.

In one aspect of the three-dimensional shaping device, a timing of changing the area of the opening by the dispensing amount adjustment unit and a timing of adjusting the pressure of the flow path by the pressure adjustment unit may be determined according to at least one of a type of the plasticized material, a temperature of the plasticized material, and a degree of change in the relative speed.

According to the three-dimensional shaping device, it is possible to change the area of the opening and adjust the pressure of the flow path, for example, at a timing suitable for the type of the plasticized material. Further, it is possible to change the area of the opening and adjust the pressure of the flow path, for example, at a timing suitable for the temperature of the plasticized material. Furthermore, it is possible to change the area of the opening and adjust the pressure of the flow path, for example, at a timing suitable for the degree of change in the relative speed.

In one aspect of the three-dimensional shaping device, the pressure of the flow path to be adjusted by the pressure adjustment unit may be determined according to a degree of change in the area of the opening.

According to the three-dimensional shaping device, the pressure of the flow path can be set to a magnitude suitable for the degree of change in the area of the opening.

In one aspect of the three-dimensional shaping device, the pressure adjustment unit may include a plunger that moves in the branch flow path, and when a position of the plunger is out of a predetermined range, the control unit may control the pressure adjustment unit to move the plunger by a predetermined amount in a direction approaching the predetermined range during shaping.

According to the three-dimensional shaping device, it is possible to prevent the plunger from moving to a limit and preventing the pressure of the flow path from being unadjustable.

In one aspect of the three-dimensional shaping device, when the control unit changes the dispensing amount to the second dispensing amount after a predetermined time when the first dispensing amount is zero, the control unit may control the dispensing amount adjustment unit to increase the area of the opening in a stepwise manner.

According to the three-dimensional shaping device, it is possible to reduce the possibility that the plasticized material flows out at once downstream of the dispensing amount adjustment unit.

In one aspect of the three-dimensional shaping device, when the control unit changes the dispensing amount from the first dispensing amount to the second dispensing amount, the control unit may control the dispensing amount adjustment unit to change the area of the opening, and then control the pressure adjustment unit in a stepwise manner to adjust the pressure of the flow path in a stepwise manner.

According to the three-dimensional shaping device, it is possible to prevent an unexpected dispensing amount.

One aspect of a plasticized material dispensing device includes: a plasticizing unit configured to plasticize a material to generate a plasticized material; a nozzle having a nozzle opening and configured to dispense the plasticized material from the nozzle opening; a dispensing amount adjustment unit configured to communicate with the nozzle opening, be provided in a flow path through which the plasticized material flows, and adjust a dispensing amount of the plasticized material from the nozzle opening by changing an area of an opening formed in the flow path; a pressure adjustment unit configured to adjust pressure of the flow path through a branch flow path coupled to the flow path between the dispensing amount adjustment unit and the nozzle opening; and a control unit configured to control the dispensing amount adjustment unit and the pressure adjustment unit. When the control unit changes the dispensing amount from a first dispensing amount to a second dispensing amount, the control unit controls the dispensing amount adjustment unit to change the area of the opening, and then controls the pressure adjustment unit to adjust the pressure of the flow path. The second dispensing amount is a dispensing amount when the plasticized material is dispensed from the nozzle opening.

What is claimed is:

1. A three-dimensional shaping device comprising:
a plasticizing unit configured to plasticize a material to generate a plasticized material;
a nozzle having a nozzle opening and configured to dispense the plasticized material from the nozzle opening toward a stage;
a dispensing amount adjustment unit configured to communicate with the nozzle opening, be provided in a flow path through which the plasticized material flows, and adjust a dispensing amount of the plasticized material from the nozzle opening by changing an area of an opening formed in the flow path;
a pressure adjustment unit configured to adjust pressure of the flow path through a branch flow path coupled to the flow path between the dispensing amount adjustment unit and the nozzle opening; and
a control unit configured to control the dispensing amount adjustment unit and the pressure adjustment unit, wherein
when the control unit changes the dispensing amount from a first dispensing amount to a second dispensing amount, the control unit controls the dispensing amount adjustment unit to change the area of the opening, and then controls the pressure adjustment unit to adjust the pressure of the flow path, and
the second dispensing amount is a dispensing amount when the plasticized material is dispensed from the nozzle opening.

2. The three-dimensional shaping device according to claim 1, wherein
the nozzle and the stage are moved relative to each other, and
when a relative speed between the nozzle and the stage is changed, the control unit changes the dispensing amount.

3. The three-dimensional shaping device according to claim 2, wherein
the control unit is configured to
control the dispensing amount adjustment unit to change the area of the opening before the relative speed is changed, and
control the pressure adjustment unit to adjust the pressure of the flow path after the area of the opening is changed and before the relative speed is changed.

4. The three-dimensional shaping device according to claim 3, wherein
a timing of changing the area of the opening by the dispensing amount adjustment unit and a timing of adjusting the pressure of the flow path by the pressure adjustment unit are determined according to at least one of a type of the plasticized material, a temperature of the plasticized material, and a degree of change in the relative speed.

5. The three-dimensional shaping device according to claim 1, wherein
the pressure of the flow path to be adjusted by the pressure adjustment unit is determined according to a degree of change in the area of the opening.

6. The three-dimensional shaping device according to claim 1, wherein
the pressure adjustment unit includes a plunger that moves in the branch flow path, and
when a position of the plunger is out of a predetermined range, the control unit controls the pressure adjustment unit to move the plunger by a predetermined amount in a direction approaching the predetermined range during shaping.

7. The three-dimensional shaping device according to claim 1, wherein
when the control unit changes the dispensing amount from the first dispensing amount, which is zero, to the second dispensing amount, the control unit controls the dispensing amount adjustment unit to increase the area of the opening in a stepwise manner.

8. The three-dimensional shaping device according to claim 1, wherein
when the control unit changes the dispensing amount from the first dispensing amount to the second dispensing amount, the control unit controls the dispensing amount adjustment unit to change the area of the opening, and then controls the pressure adjustment unit in a stepwise manner to adjust the pressure of the flow path in a stepwise manner.

9. A plasticized material dispensing device comprising:
a plasticizing unit configured to plasticize a material to generate a plasticized material;
a nozzle having a nozzle opening and configured to dispense the plasticized material from the nozzle opening;
a dispensing amount adjustment unit configured to communicate with the nozzle opening, be provided in a flow path through which the plasticized material flows, and adjust a dispensing amount of the plasticized material from the nozzle opening by changing an area of an opening formed in the flow path;
a pressure adjustment unit configured to adjust pressure of the flow path through a branch flow path coupled to the flow path between the dispensing amount adjustment unit and the nozzle opening; and
a control unit configured to control the dispensing amount adjustment unit and the pressure adjustment unit, wherein
when the control unit changes the dispensing amount from a first dispensing amount to a second dispensing amount, the control unit controls the dispensing amount adjustment unit to change the area of the opening, and then controls the pressure adjustment unit to adjust the pressure of the flow path, and
the second dispensing amount is a dispensing amount when the plasticized material is dispensed from the nozzle opening.
